(19) United States
(12) Patent Application Publication
(10) Pub. No.: US 2021/0223956 A1
(43) Pub. Date: Jul. 22, 2021

(54) MEMORY SYSTEM AND DATA PROCESSING SYSTEM INCLUDING THE SAME

(71) Applicant: SK hynix Inc., Gyeonggi-do (KR)

(72) Inventor: Byung Jun KIM, Gyeonggi-do (KR)

(21) Appl. No.: 16/922,635

(22) Filed: Jul. 7, 2020

(30) Foreign Application Priority Data
Jan. 22, 2020 (KR) 10-2020-0008426

(51) Int. Cl. G06F 3/06

(52) U.S. Cl. CPC G06F 3/064; G06F 3/0619; G06F 12/0246; G06F 3/0679; G06F 3/0656; G06F 3/0659

(57) ABSTRACT

A memory system includes a storage medium, and a controller configured to move data temporarily stored in a memory to the storage medium in units of a batch size, and to generate durability information on the data stored in the memory based on the batch size, and to transmit the durability information to a host device.

### CROSS-REFERENCE TO RELATED APPLICATION

The present application claims priority under 35 U.S.C. § 119(a) to Korean application number 10-2020-0008426, filed on Jan. 22, 2020, in the Korean Intellectual Property Office, which is incorporated herein by reference in its entirety.

### BACKGROUND

### 1. Technical Field

Various embodiments generally relate to a memory system, and more particularly, to a memory system including a nonvolatile memory apparatus.

### 2. Related Art

A memory system may store data provided from a host device in response to a write request of the host device. Furthermore, the memory system may provide the host device with stored data in response to a read request of the host device. The host device is an electronic device capable of processing data and may include a computer, a digital camera, a cellular phone and the like. The memory system may be embedded in the host device, or may be a separate device capable of being electrically connected to the host device.

### SUMMARY

A memory system and a data processing system including the same, capable of substantially preventing performance degradation caused by the processing of a flush request, are described herein.

In an embodiment, a memory system may include: a storage medium; and a controller configured to move data temporarily stored in a memory to the storage medium in units of a batch size, and to generate durability information on the data stored in the memory based on the batch size, and to transmit the durability information to a host device.

In an embodiment, an operating method of a controller may include: generating durability information based on a batch size and a size of data temporarily stored in a memory; and transmitting the durability information to a host device in response to a write request transmitted from the host device.

In an embodiment, a data processing system may include: a memory system including a storage medium and a controller; and a host device configured to transmit a write request to the controller to store data in the storage medium, wherein, in response to the write request, the controller temporarily stores the data in a memory, generates durability information for data stored in the memory, and transmits the durability information to the host device, and wherein, the host device determines whether to transmit a flush request to the controller based on the durability information.

In an embodiment, a data processing system may include: a storage medium configured to store data; a controller configured to buffer write data in a buffer, and to generate information on whether the buffered data is ready to be flushed; and a host device configured to determine, based on the information, whether to provide a flush request, wherein the controller is further configured to flush, in response to the flush request, the buffered data into the storage medium.

According to the memory system and the data processing system including the same in accordance with the embodiments, it is possible to prevent or substantially minimize performance degradation caused by the processing of a flush request.

### BRIEF DESCRIPTION OF THE DRAWINGS

FIG. 1 is a block diagram illustrating a data processing system including a memory system in accordance with an embodiment.

FIG. 2 and FIG. 3 are diagrams illustrating a method in which a controller, such as that of FIG. 1, generates durability information in response to a write request in accordance with an embodiment.

FIG. 4 is a flowchart illustrating the operation method of a controller in accordance with an embodiment.

FIG. 5 is a diagram illustrating a data processing system including a solid state drive (SSD) in accordance with an embodiment.

FIG. 6 is a diagram illustrating a data processing system including a memory system in accordance with an embodiment.

FIG. 7 is a diagram illustrating a data processing system including a memory system in accordance with an embodiment.

FIG. 8 is a diagram illustrating a network system including a memory system in accordance with an embodiment.

FIG. 9 is a block diagram illustrating a nonvolatile memory device included in a memory system in accordance with an embodiment.

### DETAILED DESCRIPTION

In the present disclosure, advantages, features and methods for achieving them will become more apparent after reading the description of the following embodiments taken in conjunction with the drawings. The present disclosure may, however, be embodied in different forms and thus should not be construed as being limited to the embodiments set forth herein. Rather, these embodiments are provided to describe the present invention in detail to the extent that a person skilled in the art to which the disclosure pertains is able to practice the present invention.

The present invention is not limited by or to any embodiment nor to the particulars disclosed herein. Further, it is noted that the drawings are not necessarily to scale and in some instances proportions may have been exaggerated in order to more clearly depict certain features of the disclosure. While particular terminology is used herein, it is to be appreciated that the terminology used herein is for the purpose of describing particular embodiments only and is not intended to limit the scope of the present invention. Also, throughout the specification, reference to “an embodiment,” “another embodiment” or the like is not necessarily to only one embodiment, and different references to any such phrase are not necessarily to the same embodiment(s).

As used herein, the term “and/or” includes any and all combinations of one or more of the associated listed items. It will be understood that when an element is referred to as being “on,” “connected to” or “coupled to” another element, it may be directly on, connected or coupled to the other element or one or more intervening elements may be present. As used herein, a singular form is intended to include the plural form, unless the context clearly indicates otherwise. It will be further understood that the terms “includes” and/or “including,” when used in this specification, specify the presence of the stated feature(s), step(s), operation(s), and/or element(s), but do not preclude the presence or addition of one or more other features, steps, operations, and/or elements.

Below, embodiments of the present disclosure are described in detail with reference to the drawings.

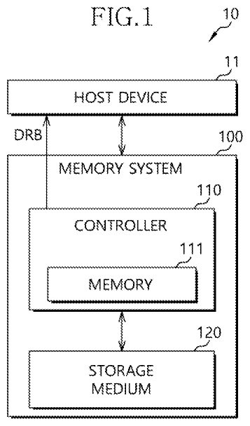

FIG. 1 is a block diagram illustrating a data processing system 10 including a memory system 100 in accordance with an embodiment.

The data processing system 10 is an electronic system capable of processing data, and may include a personal computer, a laptop computer, a smart phone, a tablet computer, a digital camera, a game console, a navigation system, a virtual reality device, a wearable device, and/or the like.

The data processing system 10 may include the memory system 100 and a host device 11.

The memory system 100 may be configured to store data provided from a host device 11 in response to a write request of the host device 11. Furthermore, the memory system 100 may be configured to provide the host device 11 with stored data in response to a read request of the host device 11.

The memory system 100 may be configured as a Personal Computer Memory Card International Association (PCMCIA) card, a Compact Flash (CF) card, a smart media card, a memory stick, various multimedia cards (MMC, eMMC, RS-MMC, and MMC-Micro), various secure digital cards (SD, Mini-SD, and Micro-SD), a Universal Flash Storage (UFS), and/or a Solid State Drive (SSD).

The memory system 100 may include a controller 110 and a storage medium 120.

The controller 110 may control overall operation of the memory system 100. The controller 110 may control the storage medium 120 in order to perform a foreground operation according to an instruction of the host device 11. Example foreground operations include an operation of writing data in the storage medium 120 and reading the data from the storage medium 120 according to the instruction of the host device 11, that is, the write request and the read request.

Furthermore, the controller 110 may control the storage medium 120 in order to perform an internally required background operation independently of the host device 11. Example background operations include a wear leveling operation, a garbage collection operation, an erase operation, a read reclaim operation, and a refresh operation for the storage medium 120. The background operation may include an operation of writing data in the storage medium 120 and/or reading the data from the storage medium 120, like the foreground operation.

The controller 110 may include a memory 111. The controller 110 may temporarily store data transmitted according to a write request from the host device 11 in the memory 111 until the data is stored in the storage medium 120. That is, the memory 111 may be used as a buffer memory.

The memory 111 may include a volatile memory apparatus. The volatile memory apparatus may include a Static Random Access Memory (SRAM), a Dynamic Random Access Memory (DRAM), and/or the like. Accordingly, data may become more durable when moved from the volatile memory 111 and stored in the nonvolatile storage medium 120.

When the size of the data temporarily stored in the memory 111 reaches a set size, the controller 110 may store the data of the set size in the storage medium 120 in one storage operation. That is, the controller 110 may batch process the write requests transmitted from the host device 11. Hereinafter, a batch size may be an amount of data that can be moved from the memory 111 to the storage medium 120 at one time, i.e., in the same operation. That is, the controller 110 may move the data from the memory 111 to the storage medium 120 in batch size units.

Furthermore, the controller 110 may store all data, which are temporarily stored in the memory 111, in the storage medium 120 at one time in response to a flush request of the host device 11. That is, when receiving the flush request from the host device 11, the controller 110 may move the data from the memory 111 to the storage medium 120 regardless of the size of the data temporarily stored in the memory 111.

In some cases, the flush request of the host device 11 may have an influence on the performance of the memory system 100. For example, when the host device 11 frequently transmits the flush request, the controller 110 needs to process the flush request in preference to other operations. Thus, the processing of the other operations may be delayed. However, in accordance with an embodiment, the controller 110 may provide the host device 11 with durability information DRB on the data temporarily stored in the memory 111, and the host device 11 may determine an appropriate time for transmitting the flush request based on the durability information DRB.

Specifically, the controller 110 may generate the durability information DRB for data stored in the memory 111 based on the batch size, and transmit the durability information DRB to the host device 11.

In accordance with an embodiment, the controller 110 may generate, as the durability information DRB, the size of data additionally required for all the data temporarily stored in the memory 111 to have durability.

In accordance with an embodiment, the controller 110 may generate, as the durability information DRB, the size of data additionally required for data corresponding to an immediately preceding write request to have durability.

In accordance with an embodiment, the controller 110 may generate, as the durability information DRB, the size of data that itself (i.e., without consideration of additional data) has durability among the data corresponding to the immediately preceding write request.

In accordance with an embodiment, the controller 110 may generate, as the durability information DRB, the size of data, other than the data that itself has durability, among the data corresponding to the immediately preceding write request. That is, the controller 110 may generate, as the durability information DRB, the size of data that itself does not have durability among the data corresponding to the immediately preceding write request.

The controller 110 may generate the durability information DRB based on the batch size, the size of data temporarily stored in the memory 111, and the size of the data corresponding to the immediately preceding write request.

Specifically, the controller 110 may generate, as the durability information DRB, the smallest positive number among values obtained by subtracting the size of the data temporarily stored in the memory 111 from multiples of the batch size. In other words, the controller 110 may generate, as the durability information DRB, a size difference obtained by subtracting the size of the data temporarily stored in the memory 111 from a lowest multiple of the batch size that is larger than the data temporarily stored in the memory 111.

In accordance with an embodiment, when the size of the data temporarily stored in the memory 111 exceeds the batch size, the controller 110 may generate, as the durability information DRB, the smallest positive number among values obtained by subtracting the multiples of the batch size from the size of the data temporarily stored in the memory 111. In other words, the controller 110 may generate, as the durability information DRB, a first size difference obtained by subtracting the highest multiple of the batch size that is less than the data temporarily stored in the memory 111 from the data temporarily stored in the memory 111. In accordance with an embodiment, when the size of the data temporarily stored in the memory 111 exceeds the batch size, the controller 110 may generate, as the durability information DRB, a value obtained by subtracting the smallest positive number from the size of data corresponding to a write request. In other words, the controller 110 may generate, as the durability information DRB, a second size difference obtained by subtracting the first size difference from a size of data corresponding to the write request.

In accordance with an embodiment, the controller 110 may generate the durability information DRB in response to a request of the host device 11 and transmit the durability information DRB to the host device 11. The type and timing of request by which the controller 110 needs to transmit the durability information DRB may be set in advance.

In accordance with an embodiment, the controller 110 may generate the durability information DRB in response to a write request transmitted from the host device 11 and transmit the durability information DRB to the host device 11. For example, the controller 110 may put the durability information DRB into a response for the write request and transmit the response to the host device 11. In accordance with an embodiment, the controller 110 may generate the durability information DRB for each write request and transmit the durability information DRB to the host device 11. In accordance with an embodiment, the controller 110 may transmit the durability information DRB to the host device 11 for a periodically selected write request.

Based on the durability information DRB transmitted from the controller 110, the host device 11 may determine whether to transmit a flush request to the controller 110. For example, based on the durability information DRB transmitted from the controller 110, the host device 11 may determine the size of data that is not yet stored in the storage medium 120 and remains in the memory 111. The host device 11 may determine a time at which there is no or little data remaining in the memory 111 (for example, when the size of the remaining data is equal to or less than a set size), and transmit the flush request to the controller 110 at such time. Therefore, the host device 11 may not transmit an unnecessary flush request to the controller 110.

Furthermore, when receiving the flush request at the time which there is no data remaining in the memory 111, the controller 110 may directly transmit a response for the flush request to the host device 11. Furthermore, when receiving the flush request at the time at which there is little data remaining in the memory 111 (i.e., the remaining data is less than or equal to the set size), the controller 110 may not spend a long time to move data from the memory 111 to the storage medium 120. Therefore, the controller 110 may quickly respond to the flush request of the host device 11, so that the memory system 100 may operate without performance degradation caused by the flush request of the host device 11.

Furthermore, based on the durability information DRB transmitted from the controller 110, the host device 11 may determine the size of data to be additionally transmitted to the memory system 100 through a subsequent write request. For example, based on the durability information DRB, the host device 11 may recognize the size of data additionally required for all data temporarily stored in the memory 111 to have durability. Accordingly, the host device 11 may transmit a subsequent write request to the controller 110 with respect to data having a size additionally required by the controller 110.

In accordance with an embodiment, the host device 11 may determine a write request to be preferentially transmitted to the memory system 100 among write requests waiting to be transmitted to the controller 110. For example, the write request to be preferentially transmitted may be a write request by which data having the size additionally required by the controller 110 may be transmitted to the controller 110.

Under the control of the controller 110, the storage medium 120 may store data transmitted from the controller 110, read the stored data, and transmit the read data to the controller 110.

The storage medium 120 may include at least one nonvolatile memory apparatus. The nonvolatile memory apparatus may include a flash memory, such as a NAND flash or a NOR flash, a Ferroelectrics Random Access Memory (FeRAM), a Phase-Change Random Access Memory (PCRAM), a Magnetoresistive Random Access Memory (MRAM), and/or a Resistive Random Access Memory (ReRAM).

The nonvolatile memory apparatus may include one or more planes, one or more memory chips, one or more memory dies, or one or more memory packages.

Also, although FIG. 1 illustrates that the memory 111 is included in the controller 110, the memory 111 may be physically located outside the controller 110 in accordance with another embodiment.

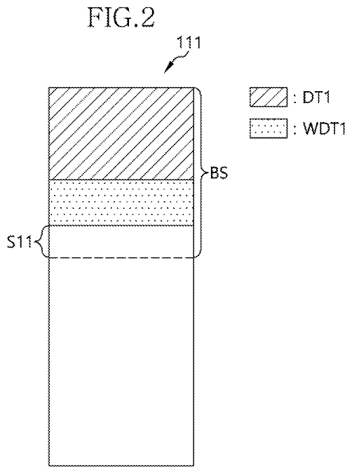

FIG. 2 and FIG. 3 are diagrams illustrating a method in which the controller 110 of FIG. 1 generates the durability information DRB in response to a write request in accordance with an embodiment.

Referring to FIG. 2, before a write request for data WDT1 is received from the host device 11, data DT1 may be already temporarily stored in the memory 111. The controller 110 may receive the write request for the data WDT1 from the host device 11 and temporarily store the data WDT1 in the memory 111.

The controller 110 may generate the durability information DRB by comparing the combined size of the data DT1 and WDT1 temporarily stored in the memory 111 with a batch size BS. The durability information DRB may include, for example, a size S11 of data additionally required for all the data DT1 and WDT1 temporarily stored in the memory 111 to have durability. That is, according to a method for generating the durability information DRB, the durability information DRB may represent the positive difference between the smallest batch size multiple that is still larger than the combined size of the data DT1 and WDT1 temporarily stored in the memory 111 and the combined size of DT1 and WDT1. The size S11 represents, or is included in, the durability information in the example of FIG. 2. The controller 110 may then transmit the durability information DRB to the host device 11 in response to the write request for the data WDT1.

Referring to FIG. 3, before a write request for data WDT2 is received from the host device 11, data DT2 may be already temporarily stored in the memory 111. The controller 110 may receive the write request for the data WDT2 from the host device 11 and temporarily store the data WDT2 in the memory 111.

The controller 110 may generate the durability information DRB by comparing the combined size of the data DT2 and WDT2 temporarily stored in the memory 111 with the batch size BS. The durability information DRB may include, for example, a size S23 of data additionally required for all the data DT2 and WDT2 temporarily stored in the memory 111 to have durability, i.e., be deemed durable. That is, according to a method for generating the durability information DRB, since the first multiple of the batch size BS is smaller than the combined size of DT2 and WDT2, the durability information DRB may be a value S23 obtained by subtracting the combined size of DT2 and WDT2 from twice the batch size BS.

In accordance with an embodiment, the durability information DRB may include a size S22 of data that itself does not have durability among the data WDT2 corresponding to the immediately preceding write request. That is, when the combined size of the data DT2 and WDT2 temporarily stored in the memory 111 exceeds the batch size BS, the durability information DRB may be a value S22 obtained by subtracting the batch size BS from the combined size of the data DT2 and WDT2 according to a method for generating, as the durability information DRB, the smallest positive number among values obtained by subtracting the multiples of the batch size BS from the combined size of the data DT2 and WDT2 temporarily stored in the memory 111.

In accordance with an embodiment, the durability information DRB may include a size S21 of data that itself has durability among the data WDT2 corresponding to the immediately preceding write request. That is, the durability information DRB may be a value S21 obtained by subtracting the value S22, which has been calculated according to the aforementioned method, from the size of the data WDT2 corresponding to the write request.

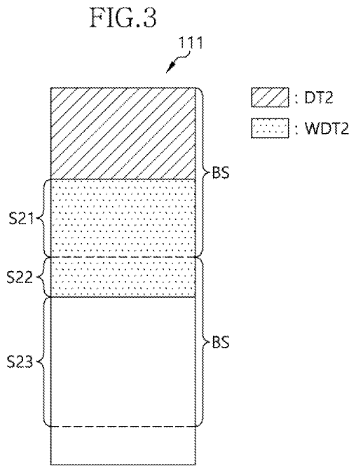

FIG. 4 is a flowchart illustrating an operation method of the controller 110 in accordance with an embodiment.

Referring to FIG. 4, in step S410, the controller 110 may receive a write request from the host device 11.

In step S420, the controller 110 may temporarily store data corresponding to the write request in the memory 111.

In step S430, the controller 110 may generate the durability information DRB based on the batch size. In accordance with an embodiment, the controller 110 may generate, as the durability information DRB, the size of data additionally required for all data temporarily stored in the memory 111 to have durability. In accordance with an embodiment, the controller 110 may generate, as the durability information DRB, the size of data additionally required for data corresponding to an immediately preceding write request to have durability. In accordance with an embodiment, the controller 110 may generate, as the durability information DRB, the size of data itself that has durability among the data corresponding to the immediately preceding write request. In accordance with an embodiment, the controller 110 may generate, as the durability information DRB, the size of additional data, i.e., other than the existing data that itself has durability, among the data corresponding to the immediately preceding write request.

In step S440, the controller 110 may transmit the durability information DRB to the host device 11.

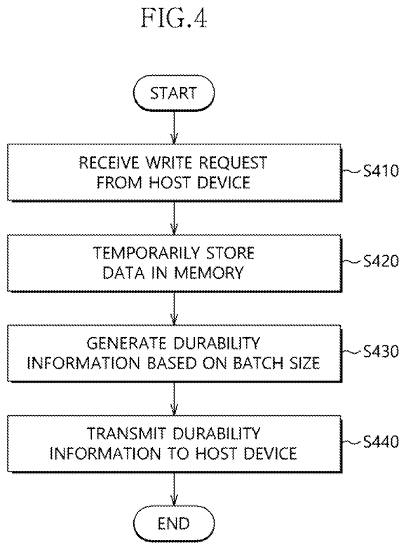

FIG. 5 is a diagram illustrating a data processing system 1000 including a solid state drive (SSD) 1200 in accordance with an embodiment. Referring to FIG. 5, the data processing system 1000 may include a host device 1100 and the SSD 1200.

The SSD 1200 may include a controller 1210, a buffer memory device 1220, a plurality of nonvolatile memory devices 1231 to 123n, a power supply 1240, a signal connector 1250, and a power connector 1260.

The controller 1210 may control general operations of the SSD 1200. The controller 1210 may be configured in the same manner as the controller 110 shown in FIG. 1. The controller 1210 may transmit durability information to the host device 1100 based on a batch size.

The controller 1210 may include a host interface 1211, a control component 1212, a random access memory 1213, an error correction code (ECC) component 1214, and a memory interface 1215.

The host interface 1211 may exchange a signal SGL with the host device 1100 through the signal connector 1250. The signal SGL may include a command, an address, data, and the like. The host interface 1211 may interface the host device 1100 and the SSD 1200 according to the protocol of the host device 1100. For example, the host interface 1211 may communicate with the host device 1100 through any one of standard interface protocols such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnection (PCI), PCI express (PCI-E) and/or universal flash storage (UFS).

The control component 1212 may analyze and process the signal SGL received from the host device 1100. The control component 1212 may control operations of internal function blocks according to firmware or software for driving the SSD 1200. The random access memory 1213 may be used as a working memory for driving such firmware or software.

The ECC component 1214 may generate the parity data of data to be transmitted to at least one of the nonvolatile memory devices 1231 to 123n. The generated parity data may be stored together with the data in the nonvolatile memory devices 1231 to 123n. The ECC component 1214 may detect an error of the data read from at least one of the nonvolatile memory devices 1231 to 123n based on the parity data. If a detected error is within a correctable range, the ECC component 1214 may correct the detected error.

The memory interface 1215 may provide control signals such as commands and addresses to at least one of the nonvolatile memory devices 1231 to 123n, according to control of the control component 1212. Moreover, the memory interface 1215 may exchange data with at least one of the nonvolatile memory devices 1231 to 123n, according to control of the control component 1212. For example, the memory interface 1215 may provide the data stored in the buffer memory device 1220 to at least one of the nonvolatile memory devices 1231 to 123n, or provide the data read from at least one of the nonvolatile memory devices 1231 to 123n to the buffer memory device 1220.

The buffer memory device 1220 may temporarily store data to be stored in at least one of the nonvolatile memory devices 1231 to 123n. Further, the buffer memory device 1220 may temporarily store the data read from at least one of the nonvolatile memory devices 1231 to 123n. The data temporarily stored in the buffer memory device 1220 may be transmitted to the host device 1100 or at least one of the nonvolatile memory devices 1231 to 123n according to control of the controller 1210.

The nonvolatile memory devices 1231 to 123n may be used as storage media of the SSD 1200. The nonvolatile memory devices 1231 to 123n may be coupled with the controller 1210 through a plurality of channels CH1 to CHn, respectively. One or more nonvolatile memory devices may be coupled to the same channel. The nonvolatile memory devices coupled to the same channel may be coupled to the same signal bus and data bus.

The power supply 1240 may provide power PWR inputted through the power connector 1260 to the inside of the SSD 1200. The power supply 1240 may include an auxiliary power supply 1241. The auxiliary power supply 1241 may supply power to allow the SSD 1200 to be properly terminated when a sudden power-off occurs. The auxiliary power supply 1241 may include large capacity capacitors.

The signal connector 1250 may be configured by any of various types of connectors depending on an interface scheme between the host device 1100 and the SSD 1200.

The power connector 1260 may be configured by any of various types of connectors depending on a power supply scheme of the host device 1100.

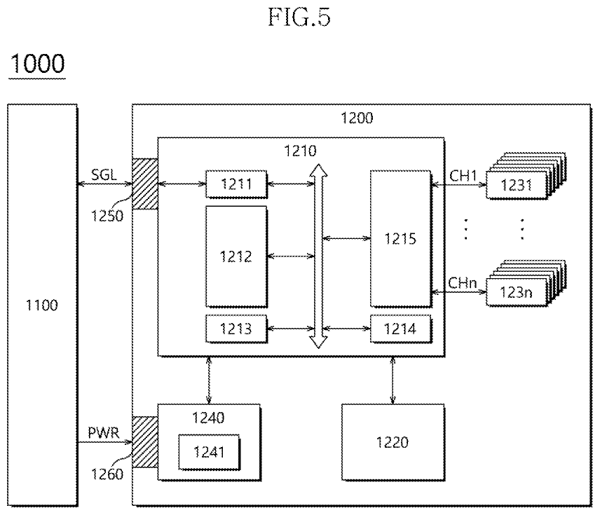

FIG. 6 is a diagram illustrating a data processing system 2000 including a memory system 2200 in accordance with an embodiment. Referring to FIG. 6, the data processing system 2000 may include a host device 2100 and the memory system 2200.

The host device 2100 may be configured in the form of a board such as a printed circuit board. Although not shown, the host device 2100 may include internal function blocks for performing the function of a host device.

The host device 2100 may include a connection terminal 2110 such as a socket, a slot or a connector. The memory system 2200 may be mounted to the connection terminal 2110.

The memory system 2200 may be configured in the form of a board such as a printed circuit board. The memory system 2200 may be referred to as a memory module or a memory card. The memory system 2200 may include a controller 2210, a buffer memory device 2220, nonvolatile memory devices 2231 and 2232, a power management integrated circuit (PMIC) 2240, and a connection terminal 2250.

The controller 2210 may control general operations of the memory system 2200. The controller 2210 may be configured in the same manner as the controller 1210 shown in FIG. 5.

The buffer memory device 2220 may temporarily store data to be stored in the nonvolatile memory devices 2231 and 2232. Further, the buffer memory device 2220 may temporarily store the data read from the nonvolatile memory devices 2231 and 2232. The data temporarily stored in the buffer memory device 2220 may be transmitted to the host device 2100 or the nonvolatile memory devices 2231 and 2232 according to control of the controller 2210.

The nonvolatile memory devices 2231 and 2232 may be used as storage media of the memory system 2200.

The PMIC 2240 may provide the power inputted through the connection terminal 2250 to the inside of the memory system 2200. The PMIC 2240 may manage the power of the memory system 2200 according to control of the controller 2210.

The connection terminal 2250 may be coupled to the connection terminal 2110 of the host device 2100. Through the connection terminal 2250, signals such as commands, addresses, data and the like, as well as power, may be transferred between the host device 2100 and the memory system 2200. The connection terminal 2250 may be configured as any of various types depending on an interface scheme between the host device 2100 and the memory system 2200. The connection terminal 2250 may be disposed on or in any side of the memory system 2200.

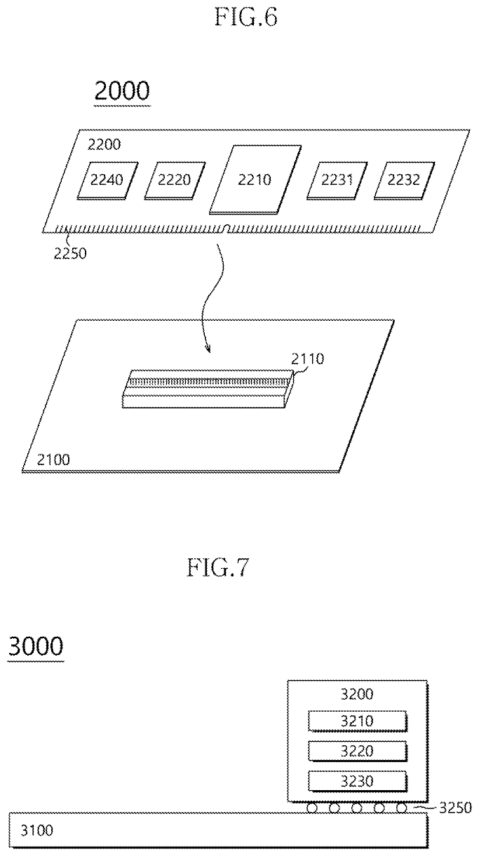

FIG. 7 is a diagram illustrating a data processing system 3000 including a memory system 3200 in accordance with an embodiment. Referring to FIG. 7, the data processing system 3000 may include a host device 3100 and the memory system 3200.

The host device 3100 may be configured in the form of a board such as a printed circuit board. Although not shown, the host device 3100 may include internal function blocks for performing the function of a host device.

The memory system 3200 may be configured in the form of a surface-mounting type package. The memory system 3200 may be mounted to the host device 3100 through solder balls 3250. The memory system 3200 may include a controller 3210, a buffer memory device 3220, and a nonvolatile memory device 3230.

The controller 3210 may control general operations of the memory system 3200. The controller 3210 may be configured in the same manner as the controller 1210 shown in FIG. 5.

The buffer memory device 3220 may temporarily store data to be stored in the nonvolatile memory device 3230. Further, the buffer memory device 3220 may temporarily store the data read from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as the storage medium of the memory system 3200.

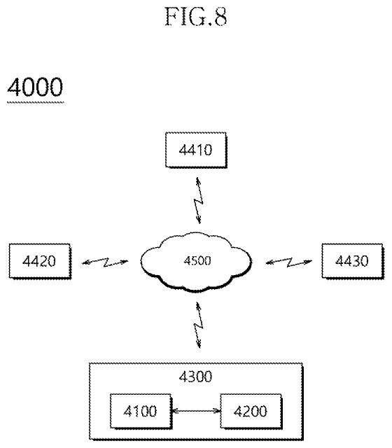

FIG. 8 is a diagram illustrating a network system 4000 including a memory system 4200 in accordance with an embodiment. Referring to FIG. 8, the network system 4000 may include a server system 4300 and a plurality of client systems 4410 to 4430 which are coupled through a network 4500.

The server system 4300 may service data in response to requests from the plurality of client systems 4410 to 4430. For example, the server system 4300 may store the data provided from the plurality of client systems 4410 to 4430. For another example, the server system 4300 may provide data to the plurality of client systems 4410 to 4430.

The server system 4300 may include a host device 4100 and the memory system 4200. The memory system 4200 may be configured by the memory system 100 shown in FIG. 1, the memory system 1200 shown in FIG. 6, the memory system 2200 shown in FIG. 7 or the memory system 3200 shown in FIG. 7.

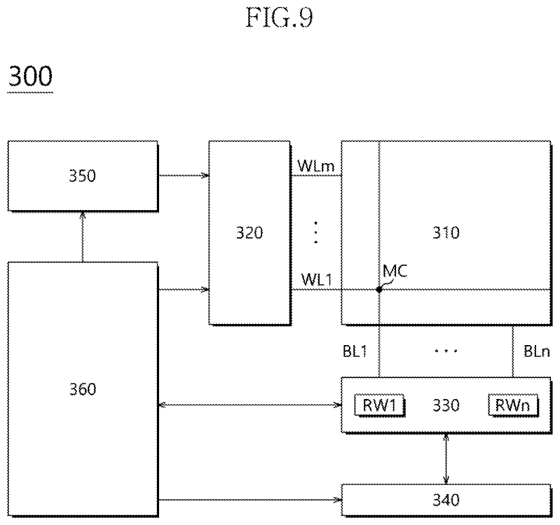

FIG. 9 is a block diagram illustrating a nonvolatile memory device 300 included in a memory system in accordance with an embodiment. Referring to FIG. 9, the nonvolatile memory device 300 may include a memory cell array 310, a row decoder 320, a data read/write block 330, a column decoder 340, a voltage generator 350, and control logic 360.

The memory cell array 310 may include memory cells MC which are arranged at areas where word lines WL1 to WLm and bit lines BL1 to BLn intersect with each other.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm based on a decoding result. For instance, the row decoder 320 may provide a word line voltage provided from the voltage generator 350 to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300 based on control signals provided from the external device. For example, the control logic 360 may control operations of the nonvolatile memory device 300 such as read, write and erase operations of the nonvolatile memory device 300.

While specific embodiments of the present disclosure have been illustrated and described, those skilled in the art will understand in light of the present disclosure that various modifications may be made to any of the disclosed embodiments within the scope of the present invention. Thus, the disclosed embodiments are examples, not limiting. That is, the present invention is not limited by or to any of the disclosed embodiments nor any specific detail provided herein. The present invention encompasses all variations and modifications that fall within the scope of the claims.

What is claimed is:

1. A memory system comprising:
a storage medium; and
a controller configured to move data temporarily stored in a memory to the storage medium in units of a batch size, and to generate durability information on the data stored in the memory based on the batch size, and to transmit the durability information to a host device.

2. The memory system according to claim 1, wherein the durability information includes a size of data additionally required, based on the batch size, for all the data stored in the memory to have durability.

3. The memory system according to claim 1, wherein the controller transmits the durability information to the host device in response to a write request transmitted from the host device.

4. The memory system according to claim 3, wherein the durability information includes a size of data additionally required, based on the batch size, for data corresponding to the write request to have durability.

5. The memory system according to claim 3, wherein the durability information includes a size of data, among data corresponding to the write request, that has durability by itself without additional data.

6. The memory system according to claim 5, wherein the durability information includes a size of data, among the data corresponding to the write request, other than the data that has durability by itself without additional data.

7. An operating method of a controller, the operating method comprising:
generating durability information based on a batch size and a size of data temporarily stored in a memory; and
transmitting the durability information to a host device in response to a write request transmitted from the host device.

8. The operating method according to claim 7, wherein the durability information includes a size difference obtained by subtracting the size of the data temporarily stored in the memory from a lowest multiple of the batch size that is larger than the data temporarily stored in the memory.

9. The operating method according to claim 7, wherein the durability information includes a first size difference obtained by subtracting the highest multiple of the batch size that is less than the data temporarily stored in the memory from the data temporarily stored in the memory.

10. The operating method according to claim 9, wherein the durability information includes a second size difference obtained by subtracting the first size difference from a size of data corresponding to the write request.

11. A data processing system comprising:
a memory system including a storage medium and a controller; and
a host device configured to transmit a write request to the controller to store data in the storage medium,
wherein, in response to the write request, the controller temporarily stores the data in a memory, generates durability information for data stored in the memory, and transmits the durability information to the host device, and
wherein, the host device determines whether to transmit a flush request to the controller based on the durability information.

12. The data processing system according to claim 11, wherein, when it is determined based on the durability information that a size of the data stored in the memory is equal to or less than a set size, the host device determines to transmit the flush request to the controller.

13. The data processing system according to claim 11, wherein, based on the durability information, the host device determines a write request, which is preferentially to be transmitted to the controller, among write requests waiting to be transmitted to the controller.

14. The data processing system according to claim 11, wherein the durability information includes a size of data additionally required, based on a batch size, for all the data stored in the memory to have durability.

15. The data processing system according to claim 11, wherein the durability information includes a size of data additionally required, based on the batch size, for the data corresponding to the write request to have durability.

16. The data processing system according to claim 11, wherein the durability information includes a size of data, among data corresponding to the write request that, based on the batch size, has durability by itself without additional data.

17. The data processing system according to claim 16, wherein the durability information includes a size of data, among the data corresponding to the write request, other than the data that has durability by itself without additional data.
